(19) United States
(12) Patent Application Publication
(10) Pub. No.: US 2013/0316645 A1
(43) Pub. Date: Nov. 28, 2013

(54) NEAR FIELD COMMUNICATION ENABLED MEDICAL DEVICE SYSTEM

(71) Applicants: Chun-Ying LI, NEW TAIPEI CITY (TW); JUN - AN CHEN, NEW TAIPEI CITY (TW); SHAN -YI YU, NEW TAIPEI CITY (TW)

(72) Inventors: Chun-Ying LI, NEW TAIPEI CITY (TW); JUN - AN CHEN, NEW TAIPEI CITY (TW); SHAN -YI YU, NEW TAIPEI CITY (TW)

(73) Assignee: HEALTH & LIFE CO., LTD.

(21) Appl. No.: 13/478,552

(22) Filed: May 23, 2012

(51) Int. Cl. H04B 5/00

(52) U.S. Cl. 455/41.1

(57) ABSTRACT

The present disclosure presents a NFC (Near Field Communication) enabled medical device system comprising: a medical device which is able to obtain an individual's at least one physiological parameter and comprises a first NFC reader/writer used to store and exchange data; a portable module comprising a first NFC tag which stores data and exchanges data with the medical device by means of the first NFC reader/writer. As such, an individual's measured and stored physiological parameters can be rapidly, conveniently, confidentially and safely transferred to specific application software in a smart mobile phone, a tablet computer or a notebook computer so as to facilitate personal health management by listing individual's physiological parameter history and producing statistical tables and charts for the physiological parameters.

### BACKGROUND OF THE INVENTION

1. Field of the Invention

The present disclosure relates to a medical device communication system, especially a NFC (Near Field Communication) enabled medical device system which depends on a NFC reader/writer to exchange data with a medical device and store data.

2. Description of the Prior Art

It is necessary for current medical equipment to transfer all kinds of measured physiological information (e.g., body temperature, pulse rate, blood pressure, blood glucose, blood oxygen saturation, EKG, ECG, and respiration parameter) by means of one transmission device which links cable network equipment or wireless network equipment but causes operations inconvenient and time-consuming due to limitations in transmission of physiological information such as connected cables, wireless pairing, and settings. Obviously, the existing method for communication of information is unideal because any physiological parameter measured by one patient himself/herself at home is difficultly transmitted in the case of a patient who is too old, disabled, or unfamiliar with operations of equipment.

On the other hand, Bluetooth installed in a transmission device for transfer of above physiological information is still an unideal way which requires complex program settings, power supply, and environmental restrictions in a mobile medical device; in addition, other drawbacks in terms of a Bluetooth connection such as poor confidentiality and security may expose an individual's physiological information and need to be corrected. Accordingly, how to solve communication-related faults of medical equipment arising from prior arts should be a critical issue for persons skilled in the arts.

In addition, a NFC (Near Field Communication) system as one contactless short-distance point-to-point communication system of equipment has evolved with a Radio Frequency Identification (RFID) system and interconnection technology integrated. Thus, the combination of a medical device and the NFC technology has become an important development tendency in virtue of accepted ISO standards based on interface and communication protocols.

To study a solution and thus develop a Near Field Communication medical device facilitating fast, convenient and safe transmission of physiological data as one means to serve the public and promote industrial development, the inventor having considered faults in information transfer of medical equipment based on prior arts produced the present invention after a long-term research.

### SUMMARY OF THE INVENTION

The present disclosure presents a Near Field Communication medical device system which facilitates measured or stored physiological parameters to be fast, conveniently, confidentially and safely transferred to specific application software installed in a smart mobile phone, a tablet computer or a notebook computer and contributes to personal health management by listing individual's physiological parameter history and producing statistical tables and charts for the physiological parameters.

To this end, the present disclosure adopts technical measures as follows: a medical device which obtains an individual's at least one physiological parameter and comprises a first NFC reader/writer used to store and exchange data; a portable module which comprises a first NFC tag used to store data and exchange data with the medical device by means of the first NFC reader/writer.

The present disclosure adopts further technical measures as follows: a medical device which obtains an individual's at least one physiological parameter and comprises a first NFC reader/writer used to store and exchange data; a portable module which comprises a second NFC reader/writer used to store data and exchange data with the medical device by means of the second NFC reader/writer.

The present disclosure adopts further technical measures as follows: a medical device which obtains an individual's at least one physiological parameter and comprises a second NFC tag used to store data; a portable module which comprises a third NFC reader/writer used to store data and exchange data with the medical device.

For technical features and effects in terms of the present disclosure completely understood and recognized, the preferred embodiments and detailed drawings are described hereinafter.

### DETAILED DESCRIPTIONS OF THE PREFERRED EMBODIMENTS

Referring to FIG. 1 which illustrates the first embodiment for the present invention of an NFC (Near Field Communication) enabled medical device system comprising a medical device 10 and a portable module 20: the medical device 10 comprises a first NFC reader/writer 11 which can be installed inside the medical device 10 and used to store data such as individual information (e.g., name, ID number, height, weight, etc.), date and time information; the first NFC reader/writer 11 is provided with a radio wave antenna 111 for data exchanged between the first NFC reader/writer 11 and the portable module 20 with a radio frequency of 13.56 MHz. The medical device 10 is able to obtain at least one physiological parameter, for instance, body temperature, pulse rate, blood pressure, blood glucose, blood oxygen saturation, electrocardiogram (EKG; ECG) and respiration parameter.

The portable module 20 comprises a first NFC tag 21 which is used to store data and exchange data with the portable module 20 through the first NFC reader/writer 11 wherein the first NFC tag 21 stores individual information (e.g., name, ID number, height, weight, etc.), date and time information. The first NFC tag 21 comprises a circuitry 22 and a radio wave antenna 23: the circuitry 22 further comprises a microchip 221, a memory 222, the memory 222 which electrically connected to the microchip 221, the microchip 221 performs reading and writing, calculation, verifying, encryption functions, the circuitry 22 is able to exchange data with the radio waves from the first NFC reader/writer 11 through the radio wave antenna 23. The memory 222 could store data, the memory 222 also could be an Electrically Erasable Programmable Read-Only Memory (EEPROM) used to store a great deal of data, in this embodiment the microchip 221 and the memory 222 also could be integrated as one.

During operations of the present invention of a NFC enabled medical device system, data will be exchanged between the medical device 10 and the first NFC tag 21 by means of the first NFC reader/writer 11 when the first NFC tag 21 approaches the medical device 10 within a specific distance (e.g., 10 cm); alternatively, the medical device 10 will be turned on when the first NFC tag 21 approaches the medical device 10 within a specific distance (e.g., 10 cm) and is detected by the first NFC reader/writer 11. In other words, the first NFC tag 21 within a detection range is activated by radio waves from the first NFC reader/writer 11 and depends on currents arising from electromagnetic induction to enable the microchip 221 on the first NFC tag 21 for emission of electromagnetic waves to respond the first NFC reader/writer 11. In appropriate embodiments, the portable module 20 is the first NFC tag 21, for instance, the portable module 20 with its shape like a coin or a piece of paper is an NFC tag;

Furthermore, the portable module 20 can be a contactless smart card, that is, a contactless smart card with the first NFC tag 21 integrated, wherein the smart card can be an Easy Card, an Octopus Card, an E-Wallet or a credit card.

The portable module 20 can be a smart mobile phone, that is, a smart mobile phone (not shown in the figure) with the first NFC tag 21 integrated. The smart mobile phone has specific application software which controls operations of the medical device 10 and allows individual information to be inputted, physiological parameter history to be listed, and statistical tables or charts for physiological parameters to be produced wherein the physiological parameter history and the statistical tables or charts for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and further comprises medical information related to the physiological parameter such as normal blood pressure limits specified by the World Health Organization (WHO) and precautions for measurement of blood glucose.

Alternatively, the portable module 20 can be a tablet computer or a notebook computer, that is, a tablet computer or a notebook computer (not shown in the figure) with the first NFC tag 21 integrated. Similarly, the tablet computer (or the notebook computer) comprises specific application software which controls operations of the medical device 10 and allows individual information to be inputted, physiological parameter history to be listed, and statistical tables or charts for physiological parameters to be produced wherein the physiological parameter history and the statistical tables or charts for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and further comprises medical information related to the physiological parameter such as normal blood pressure limits specified by the World Health Organization (WHO) and precautions for measurement of blood glucose.

Referring to FIG. 2 which illustrates the second embodiment for the present invention of a NFC enabled medical device system wherein the second embodiment is based on the first embodiment for the present invention of a NFC enabled medical device system and has some changes different from basic structures of the first one as follows: the NFC enabled medical device system comprises the medical device 10 which is identical to the medical device 10 in the first embodiment and a portable module 30 which comprises a second NFC reader/writer 31, that is, the second NFC reader/writer 31 is installed in the portable module 30; the second NFC reader/writer 31 is provided with a memory 311 and a radio wave antenna 312, stores data and exchanges data with the first NFC reader/writer 11 through radio waves from the radio wave antenna 312 wherein the stored information comprises individual information (e.g., name, ID number, height, and weight, etc.), date and time information and the radio wave antenna 312 is characteristic of a frequency of 13.56 MHz.

During operations of the present invention of a NFC enabled medical device system, data will be exchanged between the medical device 10 and the second NFC reader/writer 31 when the second NFC reader/writer 31 approaches the medical device 10 within a specific distance (e.g., 10 cm). Alternatively, the medical device 10 is turned on when the second NFC reader/writer 31 approaches the medical device 10 within a specific distance (e.g., 10 cm) and is detected by the first NFC reader/writer 11. In other words, data exchange is completed with the second NFC reader/writer 31 within a detection range activated by radio waves from the radio wave antenna 111 of the first NFC reader/writer 11 or the first NFC reader/writer 11 within a detection range activated by radio waves from the second NFC reader/writer 31.

In appropriate embodiments, the portable module 30 is the second NFC reader/writer 31, for instance, NFC ACR122U, a contactless reader/writer manufactured by DMATEC.

Alternatively, the portable module 30 can be a smart mobile phone, that is, a smart mobile phone (not shown in the figure) with the second NFC reader/writer 31 integrated. The smart mobile phone has specific application software which controls operations of the medical device 10 and allows individual information to be inputted, physiological parameter history to be listed, and statistical tables or charts for physiological parameters to be produced wherein the physiological parameter history and the statistical tables or charts for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and comprises medical information related to the physiological parameter such as normal blood pressure limits specified by the World Health Organization (WHO) and precautions for measurement of blood glucose.

Alternatively, the portable module 30 can be a tablet computer or a notebook computer, that is, a tablet computer or a notebook computer (not shown in the figure) with the second NFC reader/writer 31 integrated. Similarly, the tablet computer (or the notebook computer) comprises a specific application software which controls operations of the medical device 10 and allows individual information to be inputted, physiological parameter history to be listed, and statistical tables or charts for physiological parameters to be produced wherein the physiological parameter history and the statistical chart for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and comprises medical information related to the physiological parameter such as normal blood pressure limits specified by the World Health Organization (WHO) and precautions for measurement of blood glucose.

Referring to FIG. 3 which illustrates the third embodiment for the present invention of a NFC enabled medical device system wherein the third embodiment is based on the second embodiment for the present invention of a NFC enabled medical device system and has some changes different from the second one's basic structure as follows: the NFC enabled medical device system has a portable module 50 which comprises a third NFC (Near Field Communication) reader/writer 51, that is, the third NFC reader/writer 51 is installed in the portable module 50; the third NFC reader/writer 51 is provided with a radio wave antenna 511, stores data and exchanges data with the medical device 40 by means of the radio wave antenna 511 wherein the stored data comprises individual information (e.g., name, ID number, height, weight, etc.), date and time information and the radio wave antenna 511 is characteristic of a frequency of 13.56 MHz;

The difference between the third embodiment and the second one of the present invention is: the present invention of a NFC enabled medical device system hereinafter is provided with a medical device 40 comprising a second NFC tag 41 which stores data such as individual information (e.g., name, ID number, height, weight, etc.), date and time information, exchanges data with the portable module 50 through the third NFC reader/writer 51; The second NFC tag 41 comprises a circuitry 42 and a radio wave antenna 43: the circuitry 42 further comprises a microchip 441, a memory 412 , the memory 412 which electrically connected to the microchip 441, the microchip 441 performs reading and writing, calculation, verifying, encryption functions, the circuitry 42 is able to exchange data with the radio waves from the third NFC reader/writer 51 through the radio wave antenna 43. The memory 412 could store data, the memory 412 also could be an Electrically Erasable Programmable Read-Only Memory (EEPROM) used to store a great deal of data, in this embodiment the microchip 441 and the memory 412 also could be integrated as one. During operations of the present invention of a NFC enabled medical device system, data will be exchanged between the medical device 40 and the portable module 50 when the third NFC reader/writer 51 approaches the medical device 40 within a specific distance (e.g., 10 cm). Alternatively, the medical device 40 is turned on when the third NFC reader/writer 51 approaches the medical device 40 within a specific distance (e.g., 10 cm) and is detected by the third NFC reader/writer 51. According to the same theory, the second NFC tag 41 within a detection range is activated by radio waves from the radio wave antenna 511 of the third NFC reader/writer 51 and the second NFC tag 41 depends on currents arising from electromagnetic induction by the a radio wave antenna 43 to enable the microchip 411 on the second NFC tag 41 for emission of electromagnetic waves to respond the third NFC reader/writer 51.

In appropriate embodiments, the portable module 50 is the third NFC reader/writer 51, for instance, NFC ACR122U, a contactless reader/writer manufactured by DMATEC.

Alternatively, the portable module 50 can be a smart mobile phone, that is, a smart mobile phone (not shown in the figure) with the third NFC reader/writer 51 integrated. The smart mobile phone has a specific application software which controls operations of the medical device 40 and allows individual information to be inputted, physiological parameter history to be listed, and statistical tables or charts for physiological parameters to be produced wherein the physiological parameter history and the statistical tables or charts for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and further comprises medical information related to the physiological parameter such as normal blood pressure limits specified by the World Health Organization (WHO) and precautions for measurement of blood glucose.

Alternatively, the portable module 50 can be a tablet computer or a notebook computer, that is, a tablet computer or a notebook computer (not shown in the figure) with the third NFC reader/writer 51 integrated. Similarly, the tablet computer (or the notebook computer) comprises a specific application software which controls operations of the medical device 40 and allows individual information to be inputted, physiological parameter history to be listed, and statistical tables or charts for physiological parameters to be produced wherein the physiological parameter history and the statistical chart for physiological parameters, for example, indicate one-week blood pressures measured day and night and a bar chart of one-week blood pressures measured daily with a changeable trend clearly observed by one user, respectively; the specific application software is able to manage at least one individual's at least one physiological parameter and further comprises medical information related to the physiological parameter such as normal blood pressure limits specified by the World Health Organization (WHO) and precautions for measurement of blood glucose.

As such, the present invention of a NFC medical device system realizes that an individual's measured and stored physiological parameters can be rapidly, conveniently, confidentially and safely transferred to a specific application software in a smart mobile phone, a tablet computer or a notebook computer so as to facilitate personal health management by storing measured personal physiological parameters as history records and statistical tables or charts.

It can be seen from the above descriptions that the present invention significantly meets patentability and is applied for the patent. However, the above descriptions present preferred embodiments only which do not limit the scope of the present invention; any equivalent change or improvement based on shapes, structures, features and spirit mentioned in the present invention should be incorporated in claims.

### BRIEF DESCRIPTIONS OF THE DRAWINGS

FIG. 1 is the schematic illustration for the first embodiment of the present invention.

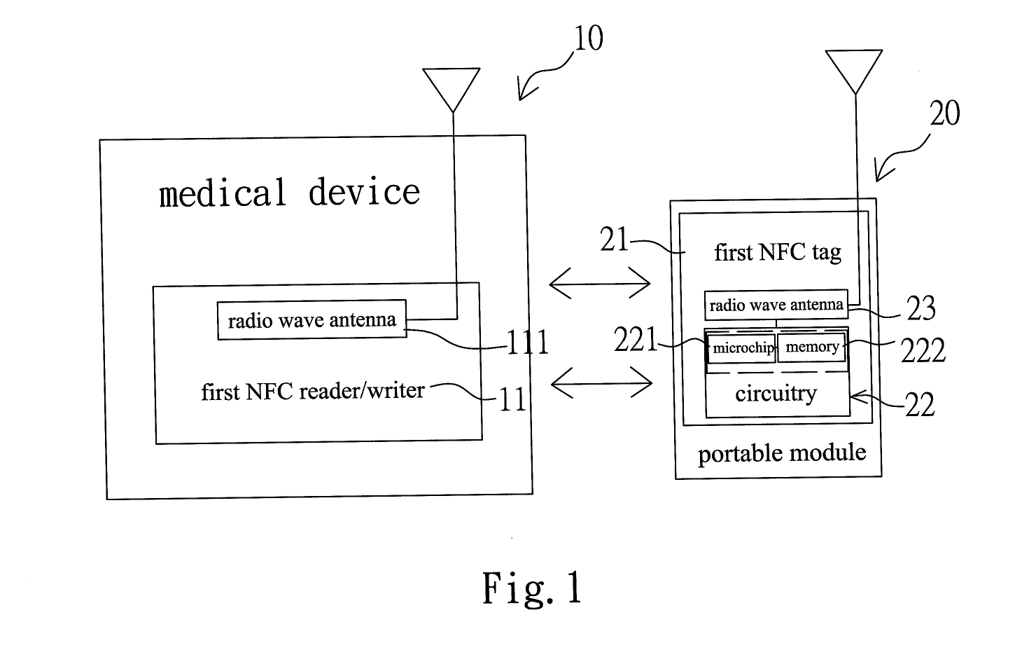

FIG. 2 is the schematic illustration for the second embodiment of the present invention.

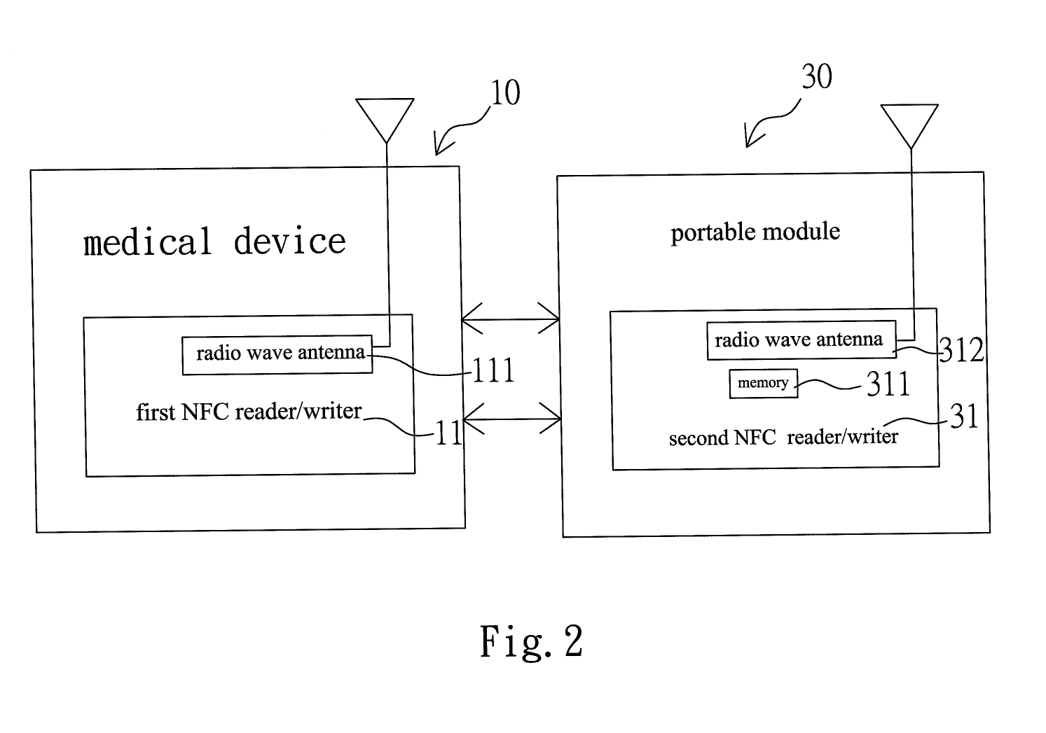

FIG. 3 is the schematic illustration for the third embodiment of the present invention.

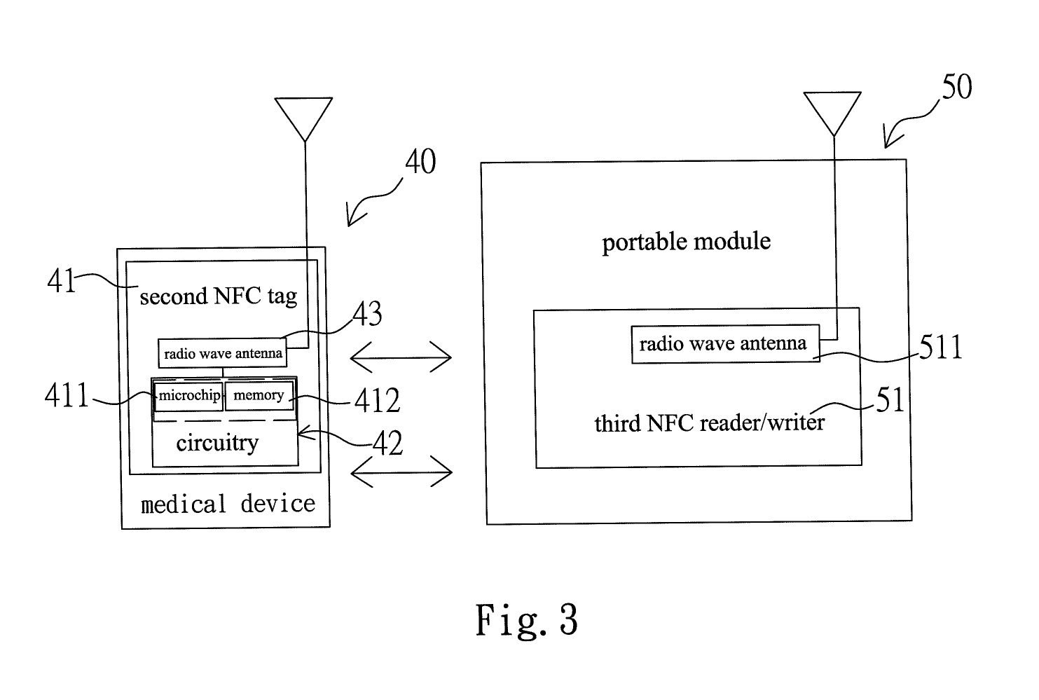

What is claimed is:

1. A NFC (Near Field Communication) enabled medical device system, comprising:
A medical device is able to obtain an individual's at least one physiological parameter and comprises a first NFC reader/writer effective in storing and exchanging data;
A portable module comprising a first NFC tag which is effective in storing data and exchanging data with said medical device by means of said first NFC reader/writer.

2. The NFC enabled medical device system according to claim 1 wherein said physiological parameter comprises: body temperature, pulse rate, blood pressure, blood glucose, blood oxygen saturation, EKG, ECG and respiration parameter.

3. The NFC enabled medical device system according to claim 1 wherein said first NFC reader/writer stores data such as personal information, date and time information.

4. The NFC enabled medical device system according to claim 1 wherein said first NFC reader/writer is provided with a radio wave antenna which emits radio waves with a frequency of 13.56 MHz to exchange data with said first NFC tag.

5. The NFC enabled medical device system according to claim 1 wherein said first NFC tag stores data such as personal information, date and time information.

6. The NFC enabled medical device system according to claim 4 wherein said first NFC tag further comprises a radio wave antenna and a circuitry which exchanges data with the radio waves from the first NFC reader/writer through the radio wave antenna.

7. The NFC enabled medical device system according to claim 6 wherein said circuitry further comprises a microchip which performs reading and writing, calculation, verifying, encryption functions.

8. The NFC enabled medical device system according to claim 7 wherein said circuitry further comprises a memory which electrically connected to said microchip and the memory being an Electrically Erasable Programmable Read-Only Memory (EEPROM) for storage of a great deal of data.

9. The NFC enabled medical device system according to claim 1 wherein data can be exchanged between said medical devices and said first NFC tag when said first NFC tag approaches said medical device within a specific distance.

10. The NFC enabled medical device system according to claim 9 wherein said specific distance is 10 cm.

11. The NFC enabled medical device system according to claim 1 wherein said medical device is turned on when said first NFC tag approaches said medical device within a specific distance and is detected by said first NFC reader/writer.

12. The NFC enabled medical device system according to claim 11 wherein said specific distance is 10 cm.

13. The NFC enabled medical device system according to claim 1 wherein said portable module itself is said first NFC tag.

14. The NFC enabled medical device system according to claim 1 wherein said first NFC tag is integrated with a contactless smart card.

15. The NFC enabled medical device system according to claim 1 wherein said first NFC tag is integrated with a smart mobile phone which comprises a specific application software.

16. The NFC enabled medical device system according to claim 15 wherein said specific application software controls operations of said medical device and allows individual information to be inputted.

17. The NFC enabled medical device system according to claim 15 wherein said specific application software lists physiological parameter history and produces statistical tables or charts for said physiological parameter.

18. The NFC enabled medical device system according to claim 15 wherein said specific application software manages at least one individual's at least one physiological parameter and comprises medical information related to said physiological parameter.

19. The NFC enabled medical device system according to claim 1 wherein said first NFC tag is integrated with a tablet computer or a notebook computer which comprises a specific application software.

20. The NFC enabled medical device system according to claim 19 wherein said specific application software controls operations of said medical device and allows individual information to be inputted.

21. The NFC enabled medical device system according to claim 19 wherein said specific application software lists physiological parameter history and produces statistical tables and charts for said physiological parameter.

22. The NFC enabled medical device system according to claim 19 wherein said specific application software manages at least one individual's at least one physiological parameter and further comprises medical information related to said physiological parameter.

23. A NFC enabled medical device system, comprising:
A medical device which is able to obtain an individual's at least one physiological parameter and comprises a first NFC reader/writer used to store and exchange data;
A portable module comprising a second NFC reader/writer used to store data and exchange data with said medical device by means of said second NFC reader/writer.

24. The NFC enabled medical device system according to claim 23 wherein said physiological parameter comprises: body temperature, pulse rate, blood pressure, blood glucose, blood oxygen saturation, EKG, ECG and respiration parameter.

25. The NFC enabled medical device system according to claim 23 wherein said first NFC reader/writer stores data such as personal information, date and time information.

26. The NFC enabled medical device system according to claim 23 wherein said first NFC reader/writer is provided with a radio wave antenna which emits radio waves with a frequency of 13.56 MHz for data exchanged between said first NFC reader/writer and said second NFC reader/writer.

27. The NFC enabled medical device system according to claim 23 wherein said second NFC reader/writer stores data such as personal information, date and time information.

28. The NFC enabled medical device system according to claim 23 wherein said second NFC reader/writer further comprises a radio wave antenna, stores data, and exchanges data with said first NFC reader/writer through radio waves from said radio wave antenna.

29. The NFC enabled medical device system according to claim 23 wherein data is exchanged between said medical devices and said second NFC reader/writer when said second NFC reader/writer approaches said medical device within a specific distance.

30. The NFC enabled medical device system according to claim 29 wherein said specific distance is 10 cm.

31. The NFC enabled medical device system according to claim 23 wherein said medical device is turned on when said second NFC reader/writer approaches said medical device within a specific distance and is detected by said first NFC reader/writer.

32. The NFC enabled medical device system according to claim 31 wherein said specific distance is 10 cm.

33. The NFC enabled medical device system according to claim 23 wherein said portable module itself is said second NFC reader/writer.

34. The NFC enabled medical device system according to claim 23 wherein said second NFC reader/writer is integrated with a smart mobile phone which comprises a specific application software.

35. The NFC enabled medical device system according to claim 34 wherein said specific application software controls operations of said medical device and allows individual information to be inputted.

36. The NFC enabled medical device system according to claim 34 wherein said specific application software lists physiological parameter history and produces statistical tables or charts for said physiological parameter.

37. The NFC enabled medical device system according to claim 34 wherein said specific application software manages at least one individual's at least one physiological parameter and comprises medical information related to said physiological parameter.

38. The NFC enabled medical device system according to claim 34 wherein said NFC reader/writer is integrated with a tablet computer or a notebook computer which comprises a specific application software.

39. The NFC enabled medical device system according to claim 38 wherein said specific application software controls operations of said medical device and allows individual information to be inputted.

40. The NFC enabled medical device system according to claim 38 wherein said specific application software lists physiological parameter history and produces statistical tables or charts for said physiological parameter.

41. The NFC enabled medical device system according to claim 38 wherein said specific application software manages at least one individual's at least one physiological parameter and further comprises medical information related to said physiological parameter.

42. A NFC enabled medical device system, comprising:
A medical device which is able to obtain an individual's at least one physiological parameter and comprises a second NFC tag used to store data;
A portable module which comprises a third NFC reader/writer used to exchange data with said medical device and store data.

43. The NFC enabled medical device system according to claim 42 wherein said physiological parameter comprises: body temperature, pulse rate, blood pressure, blood glucose, blood oxygen saturation, EKG, ECG, and respiration parameter.

44. The NFC enabled medical device system according to claim 42 wherein said second NFC tag stores data such as personal information, date and time information.

45. The NFC enabled medical device system according to claim 42 wherein said third NFC reader/writer is provided with a radio wave antenna which emits radio waves with a frequency of 13.56 MHz for data exchanged between said third NFC reader/writer and said second NFC tag.

46. The NFC enabled medical device system according to claim 42 wherein said third NFC reader/writer stores data such as personal information, date and time information.

47. The NFC enabled medical device system according to claim 45 wherein said second NFC tag further comprises a radio wave antenna and a circuitry which exchanges data with the radio waves from the third NFC reader/writer through the radio wave antenna.

48. The NFC enabled medical device system according to claim 47 wherein said circuitry further comprises a microchip which performs reading and writing, calculation, verifying, encryption functions.

49. The NFC enabled medical device system according to claim 48 wherein said circuitry further comprises a memory which electrically connected to said microchip and the memory being an Electrically Erasable Programmable Read-Only Memory (EEPROM) for storage of a great deal of data.

50. The NFC enabled medical device system according to claim 42 wherein data is exchanged between said medical devices and said third NFC reader/writer when said third NFC reader/writer approaches said medical device within a specific distance.

51. The NFC enabled medical device system according to claim 50 wherein said specific distance is 10 cm.

52. The NFC enabled medical device system according to claim 42 wherein said medical device is turned on when said third NFC reader/writer approaches said medical device within a specific distance and is detected by said third NFC reader/writer.

53. The NFC enabled medical device system according to claim 52 wherein said specific distance is 10 cm.

54. The NFC enabled medical device system according to claim 42 wherein said portable module itself is said third NFC reader/writer.

55. The NFC enabled medical device system according to claim 42 wherein said third NFC reader/writer is integrated with a smart mobile phone which comprises a specific application software.

56. The NFC enabled medical device system according to claim 55 wherein said specific application software controls operations of said medical device and allows individual information to be inputted.

57. The NFC enabled medical device system according to claim 55 wherein said specific application software lists physiological parameter history and produces statistical tables or charts for said physiological parameter.

58. The NFC enabled medical device system according to claim 55 wherein said specific application software manages at least one individual's at least one physiological parameter and further comprises medical information related to said physiological parameter.

59. The NFC enabled medical device system according to claim 42 wherein said third NFC reader/writer is integrated with a tablet computer or a notebook computer which comprises a specific application software.

60. The NFC enabled medical device system according to claim 59 wherein said specific application software controls operations of said medical device and allows individual information to be inputted.

61. The NFC enabled medical device system according to claim 59 wherein said specific application software lists physiological parameter history and produces statistical tables or charts for said physiological parameter.

62. The NFC enabled medical device system according to claim 59 wherein said specific application software manages at least one individual's at least one physiological parameter and further comprises medical information related to said physiological parameter.
